(19) United States
(12) Patent Application Publication
(10) Pub. No.: US 2008/0235905 A1
(43) Pub. Date: Oct. 2, 2008

(54) Pre-Tension Anchorage for Spiral Balance

(75) Inventor: Robert M. Lucci, Rochester, NY (US)

Correspondence Address: BROWN & MICHAELS, PC;400 M & T BANK BUILDING, 118 NORTH TIOGA ST, ITHACA, NY, 14850, US

(73) Assignee: CALDWELL MANUFACTURING COMPANY, INC., Rochester, NY (US)

(21) Appl. No.: 11/694,164

(22) Filed: Mar. 30, 2007

(51) Int. Cl. E05D 13/00

(52) U.S. Cl. 16/197

(57) ABSTRACT

A method and device for applying a pre-tensioned force to a spiral window balance. The spiral balance includes a containment tube, a spiral rod and a torsion spring that traverses the length of the containment tube. The device includes a pre-tensioning insert that is contained within an anchorage fixed within the upper end of the containment tube. At least one boss formed at the base of a bore within the pre-tensioning insert defines a channel that receives the upper end of the spiral rod. To apply a pre-tensioned force to the spiral balance, the lower end of the spiral rod is pulled from the lower end of the containment tube, turned a number of revolutions and reinserted into the containment tube without being allowed to rotate. The upper end of the spiral rod is non-rotatably retained within the channel by the boss to prevent it from losing its pre-tensioned force.

### FIELD OF THE INVENTION

The invention pertains to the field of window sash balances having spiral rods which are encased in a containment tube. More particularly, the invention pertains to an anchoring means inside the tube that enables the balance manufacturer to apply a pre-tensioned force to the spiral rod prior to shipment to a window manufacturer.

### BACKGROUND OF THE INVENTION

Window sash balance devices are designed to offset or counteract the weight of the sash in order to assist in the raising and lowering of the sash. Springs are utilized to provide a counterbalancing force. Both tension and torsion springs have been used to this end.

Torsion springs are most desired because they can be designed to provide a more constant lifting force over the full travel of the sash. Torsional spring force is converted into a lifting force by an elongated spiral rod. The torsion spring and elongated spiral rod are all housed within a containment tube which protects the moving parts of the balance system from contamination.

The upper end of the containment tube is secured to the jamb channel, for example, by a bolt, screw, rivet or other fastener, depending on the design preferences of the window manufacturer. The lower end of the containment tube is capped by a rotatable coupling having a center slot for operatively engaging the elongated spiral rod. The lower end of the elongated spiral rod may contain at least one pin or pin securely fitted perpendicularly to the axis of the rod to allow a shoe to hook thereon. The shoe is fixed to the sash and traverses up and down the jamb channel of the window assembly.

Spiral sash balances are generally shipped to the window manufacturer with no pre-tension applied to the spiral rod. It is up to the window manufacturer to then apply a pre-tensioned force to the balance during assembly to a window frame. Tensioning the balance is traditionally performed by the window manufacturer during assembly of the window. The upper end of the balance containment tube is secured to the jamb channel by any of a variety of standard mounting means. Then, using a specialized tool, the other end of the spiral rod is pulled a specific distance out of the lower end of the balance containment tube and rotated a set number of turns with respect to the containment tube. The spiral rod is then attached to the shoe without permitting the rod to rotate back to an untensioned position. However, the tensioning process is awkward after the balance containment tube has been secured to the window jamb channel. Further, inconsistent tensioning of the balance, such as by turning the spiral rod too many times or too few, is a common problem. In addition, a balance that is not pre-tensioned must be handled carefully before assembly onto the window frame because an un-tensioned rod may fall out of the containment tube if is accidentally tilted.

Therefore, many window manufacturers would prefer that the balance manufacturer apply a specified pre-tensioned force to the spiral balance prior to shipment. However, some conventional methods used to apply a pre-tensioning force to the spiral rod consist of forming grooves or tabs within the upper end of the containment tube or an anchor installed within the upper end of the tube. Since the grooves or tabs must be placed far enough away from the end of the containment tube to ensure structural integrity, there is a significant amount of lost travel associated with the tensioned spiral rod. This ultimately results in a loss of the potential amount of travel of the sash though the jamb channel.

### SUMMARY OF THE INVENTION

In a window sash balance consisting of a spiral rod tensioned by a torsion spring encased within a containment tube, the present invention enables the balance manufacturer to apply a specific amount of pre-tensioned force to the spiral rod prior to shipment to the window manufacturer. The apparatus of the invention consists of a pre-tensioning insert that is non-rotatably secured to an anchorage which itself is secured to the upper end of the containment tube. The pre-tensioning insert has an internal bore that is disposed in the direction of the spiral rod. The inner diameter of the internal bore contains at least one boss that forms a recess or channel for receiving and preventing the rotation of the upper end of the tensioned spiral rod.

In operation, after the spiral balance is assembled, a conventional tool may be used to pull the lower end of the spiral rod out of the lower end of the containment tube a pre-determined distance. The rod is then turned a set number of revolutions to apply a calculated amount of pre-tensioning force to the spiral balance, then the spiral rod is retracted into the containment tube without being allowed to twist back to its resting position. As the spiral rod is fully retracted into the containment tube, the upper end of the rod seats into the channel within the base of the internal bore of the pre-tensioning insert, thereby preventing it from turning and losing the pre-tensioned force that was applied to it.

The use of a pre-tensioning insert within the anchor of the upper end of the containment tube provides for a means to pre-tension a spiral sash balance that results in less travel loss than experienced by conventional pre-tensioning methods or devices. Travel loss from the balance is an undesired consequence of conventional pre-tensioning techniques. The less travel loss, the better, because the sash is allowed a greater potential range of travel up and down the window jamb channel. The pre-tensioning insert of the invention requires only about 0.2 inch to engage and lock the elongated spiral rod. However, conventional pre-tensioning methods and devices require about 0.3 inches or more to perform the same task. While seemingly small, this difference is significant to window manufacturers and represents an appreciable technological advancement.

### BRIEF DESCRIPTION OF THE DRAWINGS

FIG. 1 shows a cross-section of a spiral sash balance of the invention.

FIG. 2 shows an isometric view of the anchorage located at the upper end of the containment tube.

FIG. 3 shows a side perspective view of the pre-tensioning insert of the invention.

FIG. 4 shows an isometric view of the pre-tensioning insert.

FIG. 5 shows a plan view looking into the recess of the pre-tensioning insert, showing one configuration of the bosses and groove.

FIG. 6 shows a cross sectional view of the pre-tensioning insert.

### DETAILED DESCRIPTION OF THE INVENTION

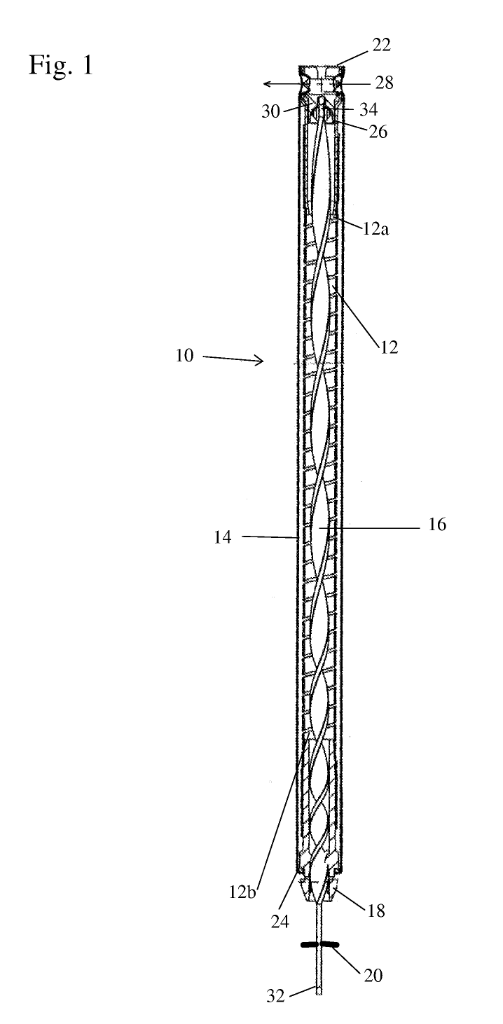

Referring to FIG. 1, a cross section of a spiral sash balance 10 is shown. It consists of a containment tube 14 that contains a torsion spring 12 and an elongated spiral rod 16. An internal anchorage 26 is securely installed at the upper end 22 of the containment tube for securing a fixed end 12a of the torsion spring 12. The opposite or rotatable end 12b of the torsion spring 12 is positioned at the lower end 24 of the containment tube 14 and is secured to a coupling 18 that is inserted into the lower end of the containment tube. The coupling 18 contains an axially positioned slot allowing the elongated spiral rod 16 to slidably traverse therethrough. The coupling 18 is freely rotatable with respect to the lower end 24 of the containment tube 14.

The first end 32 of the elongated spiral rod 16 extends through the slot in the coupling 18. Preferably, at least one pin 20 is perpendicularly secured to the elongated spiral rod 16 in proximity to the first end 32 of the elongated spiral rod 16. The one or more pin may latch onto a hook on a balance shoe that rides up and down the window jamb channel (not shown). The second end 34 of the elongated spiral rod 16 retracts into the anchorage 26 at the upper end 22 of the containment tube 14.

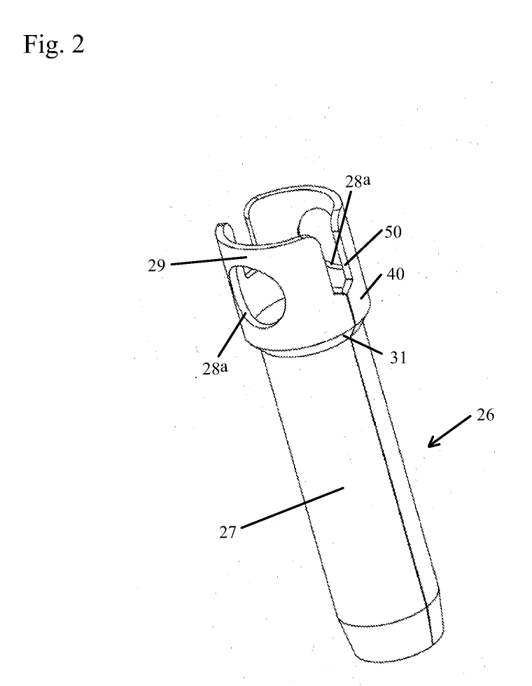

The upper end 22 of the containment tube 14 is secured to the jamb channel by means of a fastener (not shown) that is installed transversely through diametrically opposed mounting holes (identified by arrow 28 in FIG. 1) formed in the wall of the containment tube 14. The mounting holes 28 are in proximity to the upper end 22 of the containment tube 14, and align with holes 28a in anchorage 26 (FIG. 2). The anchorage 26 consists of two regions, a narrow diameter region 27 and a larger diameter region 29. The two regions are connected by an annular shoulder 31. At least one slot 50 is formed along the axis of the anchorage 26 in its larger diameter region 29. The anchorage 26 is inserted into the upper end 22 of the containment tube 14 and is secured in place as the wall of the containment tube 14 is punched at diametrically opposed locations to form mounting holes 28. The metal bent over from the punches into holes 28a securely retains the anchorage 26 in place at the upper end 22 of the containment tube 14.

In operation, the stile of the sash is connected to a balance shoe that traverses up and down the jamb channel of the window assembly. As the sash is moved downwardly, the shoe pulls the elongated spiral rod 16 downward out of the containment tube 14. As the elongated spiral rod 16 continues its traversal out of the lower end of the containment tube 14, its spiral configuration causes the coupling 18 to rotate which, in turn, twists and tightens the torsion spring 12, resulting in a progressively increasing resistive force proportional to the continued extension of the elongated spiral rod 16 out of the containment tube 14. As the sash is returned to its initial position, the elongated spiral rod 16 returns to its resting position within the containment tube 14 with the assistance of the recoiling motion of the torsion spring 12 as it returns to its resting or state of lowest tension.

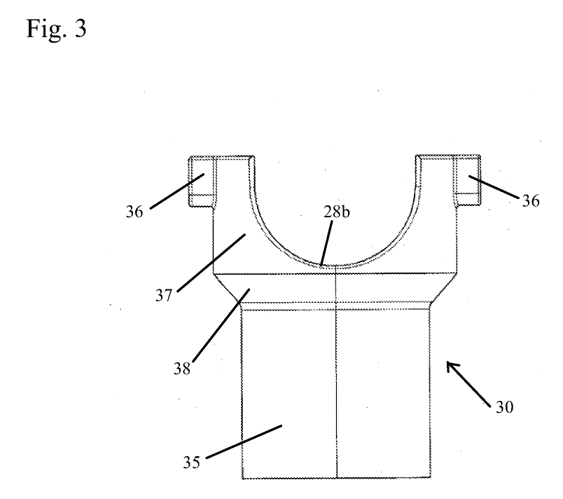

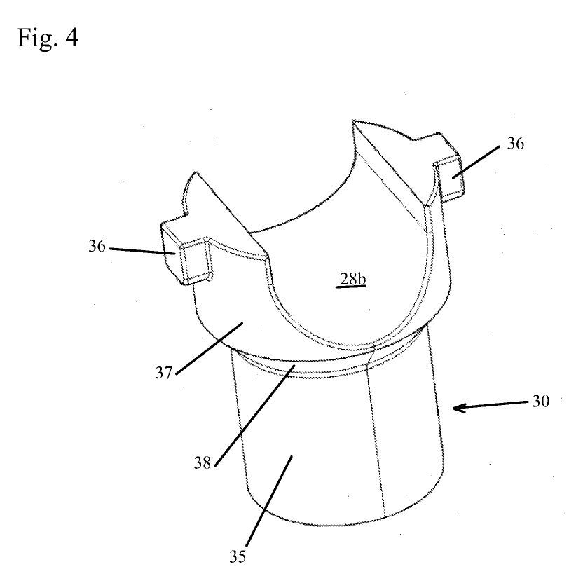

The present invention enables the balance manufacturer to apply a pre-tension force to the spiral sash balance 10, thereby eliminating the tensioning operation from the window manufacturer's assembly protocol and ensuring the application of a more consistent tension on the balance. This is achieved by providing a pre-tensioning insert 30, as shown in a side plan view in FIG. 3 and in an isometric view in FIG. 4. The pre-tensioning insert 30 consists of a cylindrical body region 35 integrally connected to an upper body region 37 having a larger outer diameter than the outer diameter of the cylindrical body region 35. An annular taper 38 integrally joins the outer diameter of the cylindrical body region 35 with the outer diameter of the upper body region 35. A groove 28b having either a radial, V-shaped or rectangular shaped profile is formed in the upper body region 37. Preferably, the groove 28b has a radius substantially similar to the diameters of the mounting holes 28 and 28a. Positioned substantially perpendicularly to the axis of the groove 28b in the upper body region 37 is at least one outwardly projecting tab 36. Preferably two outwardly projecting tabs 36 are positioned diametrically opposed to each other, as shown in FIGS. 3 and 4.

The pre-tensioning insert 30 is installed into the larger diameter region 29 of the anchorage 26. Each tab 36 of the pre-tensioning insert 30 slides down a corresponding slot 50 in anchorage 26 until the tab 36 is firmly seated at the bottom of the slot 50. The groove 28b of the pre-tensioning insert 30 aligns with the holes 28a in the anchorage and the holes 28 in the walls of the containment tube 14. The annular taper 38 of the pre-tensioning insert 30 seats against the internal surface of the annular shoulder 31 of the anchorage. Once the pre-tensioning insert 30 is installed within the anchorage 26 and the anchorage 26 is installed within the upper end 22 of the containment tube 14, the three structural elements may be firmly secured to each other by forming an inwardly projecting upset through the wall of the containment tube 14 into at least one of the slots 50 so that each outwardly projecting tab 36 of the pre-tensioning insert 30 is firmly locked into place at the bottom of its corresponding slot 50.

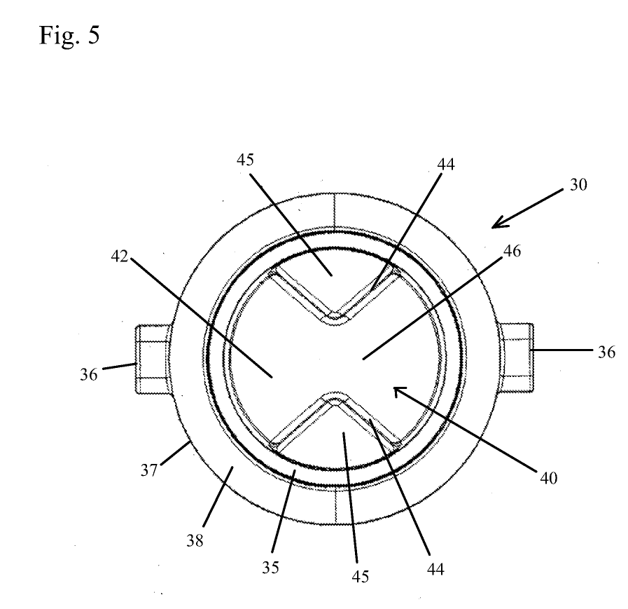

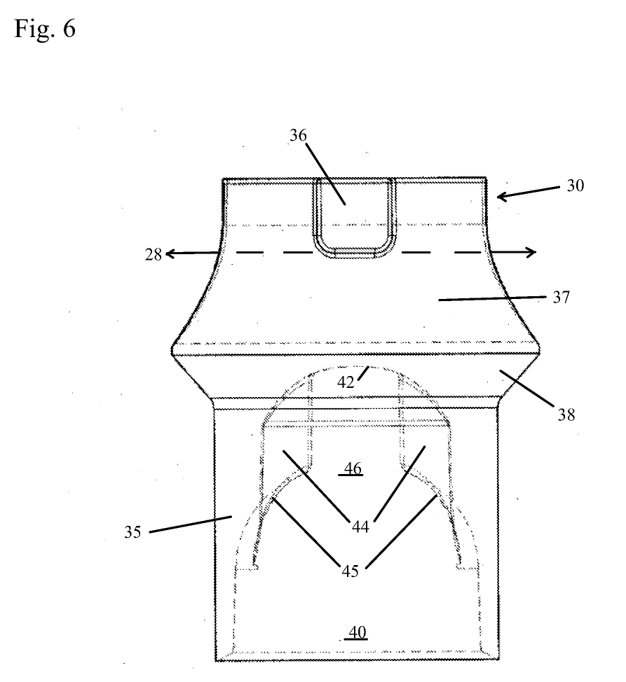

The pre-tensioning insert 30 contains a hollow internal bore 40 (FIG. 5) that is disposed in the direction of the second end 34 of the elongated spiral rod 16. The internal bore 40 terminates in a base 42 from which at least one boss or tab 44 extends. The boss 44 is integrally formed at the junction between the inner wall of the bore 40 and the base 42. The one or more boss 44 creates a channel 46 (FIGS. 5 and 6) to firmly seat the second end 34 of the elongated spiral rod 16 against the base 42 of the pre-tensioning insert 30 when the elongated spiral rod is fully retracted within the containment tube 14. The cross section of each boss 44, when viewed from the open end of the internal bore 40 toward the base 42, may take a shape approximating a triangle, an oval, a circle, a hemi-sphere or any suitable form to perform the required purpose of creating the channel 46 on the surface of the base 42.

As best shown in FIG. 6, at least one boss 44 may have a tapered side 45 in order to guide the second end 34 of the elongated spiral rod 16 to seat in the groove 46. The window manufacturer can specify to the balance manufacturer the precise amount of pre-tensioned force desired for each balance type. The use of the pre-tensioning insert 30 of the present invention reduces the travel loss that is so critical to the window manufacturers in that it requires only about 0.2 inch to engage and lock the second end 34 of the elongated spiral rod 16.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. In a spiral sash balance including a containment tube having an upper end and a lower end, an elongated spiral rod having a first end and a second end, a torsion spring having a fixed end and a rotatable end secured to a coupling, the coupling rotatably disposed on the lower end of the containment tube and operatively engaged with and in proximity to the first end of the elongated spiral rod, wherein the second end of the elongated spiral rod is biased toward the upper end of the containment tube, the improvement comprising:
an anchorage in the upper end of the containment tube to which the fixed end of the torsion spring is securely attached, the anchorage having a hole alignable with a hole in the containment tube;
a pre-tensioning insert non-rotatably disposed within the anchorage, the pre-tensioning insert having:
a groove alignable with both the hole in the containment tube and the hole in the anchorage tube for receiving means to secure the spiral balance in place; and
an internal bore having an open end disposed toward the second end of the elongated spiral rod, the internal bore having a base and an inner wall and at least one boss at the junction of the inner wall and the base;
wherein the at least one boss is configured to form a channel in the base of the internal bore to receive and non-rotatably secure the second end of the elongated spiral rod.

2. The pre-tension anchorage of claim 1 wherein a side of the at least one boss is tapered to bias the second end of the elongated spiral rod to seat in the channel in the base of the internal bore.

3. The pre-tension anchorage of claim 1 wherein the at least one boss is substantially triangle shaped when viewed from the open end of the internal bore.

4. The pre-tension anchorage of claim 1 wherein the at least one boss is substantially oval shaped when viewed from the open end of the internal bore.

5. The pre-tension anchorage of claim 1 wherein the at least one boss is substantially circle shaped when viewed from the open end of the internal bore.

6. The pre-tension anchorage of claim 1 wherein the at least one boss is substantially hemi-sphere shaped when viewed from the open end of the internal bore.

7. A pre-tensioning insert for enabling a pre-tensioned force to be applied to a spiral window balance; the spiral window balance including a containment tube having an upper end and a lower end, an elongated spiral rod having a first end and a second end, a torsion spring having a fixed end and a rotatable end secured to a coupling, the coupling rotatably disposed on the lower end of the containment tube and operatively engaged with and in proximity to the first end of the elongated spiral rod, wherein the second end of the elongated spiral rod is biased toward the upper end of the containment tube; the pre-tensioning insert comprising:
a cylindrically shaped body having a larger diameter region and a smaller diameter region, the larger diameter region integrally connected to the smaller diameter region by an annular taper;
an internal bore having an open end, an internal wall and a base;
at least one boss at the junction of the base and the internal wall;
a groove through the larger diameter region disposed substantially perpendicular to the axis of the pre-tensioning insert; and
at least one outwardly projecting tab on the surface of the larger diameter region.

8. The pre-tensioning insert of claim 7 disposed within and in proximity to the upper end of the containment tube so that the open end of the internal bore is positioned to receive the second end of the elongated spiral rod.

9. The pre-tensioning insert of claim 7 wherein the at least one boss forms a channel in the base.

10. The pre-tensioning insert of claim 9 wherein the channel receives and substantially prevents the rotation of the second end of the elongated spiral rod.

11. The pre-tensioning insert of claim 7 wherein the at least one boss is substantially triangle shaped when viewed from the open end of the internal bore.

12. The pre-tensioning insert of claim 7 wherein the at least one boss is substantially oval shaped when viewed from the open end of the internal bore.

13. The pre-tensioning insert of claim 7 wherein the at least one boss is substantially circle shaped when viewed from the open end of the internal bore.

14. The pre-tensioning insert of claim 7 wherein the at least one boss is substantially hemi-sphere shaped when viewed from the open end of the internal bore.

15. In a spiral sash balance including a containment tube having an upper end and a lower end, an elongated spiral rod having a first end and a second end, a torsion spring having a fixed end and a rotatable end secured to a coupling, the coupling rotatably disposed on the lower end of the containment tube and operatively engaged with the elongated spiral rod, an anchorage secured to the first end of the torsion spring and non-rotatably contained within the upper end of the containment tube, a pre-tensioning insert non-rotatably contained within the anchorage, the pre-tensioning insert having an open end and an internal bore containing at least one boss projecting from a base of the bore to form a channel, wherein the second end of the elongated spiral rod is biased toward the internal bore; a method for applying a pre-tensioned force to the spiral sash balance comprising:
withdrawing the elongated spiral rod from the rotatable coupling, turning the elongated spiral rod a predetermined number of revolutions with respect to the containment tube to apply a pre-tensioned force to the spiral balance; and
allowing the elongated spiral rod to retract into the containment tube and firmly seat within the channel in the base of the internal bore of the pre-tensioning insert without allowing the elongated spiral rod to rotate back to an untensioned position.

16. The method of claim 15 wherein the at least one boss is substantially triangle shaped when viewed from the open end of the internal bore.

17. The method of claim 15 wherein the at least one boss is substantially oval shaped when viewed from the open end of the internal bore.

18. The method of claim 15 wherein the at least one boss is substantially circle shaped when viewed from the open end of the internal bore.

19. The method of claim 15 wherein the at least one boss is substantially hemi-sphere shaped when viewed from the open end of the internal bore.
